(19) United States
(12) Patent Application Publication
(10) Pub. No.: US 2025/0005928 A1
(43) Pub. Date: Jan. 2, 2025

(54) VIDEO PROCESSING APPARATUS, METHOD, AND PROGRAM

(71) Applicant: NIPPON TELEGRAPH AND TELEPHONE CORPORATION, Tokyo (JP)

(72) Inventors: Chao WU, Tokyo (JP); Shingo HORIUCHI, Tokyo (JP); Kenji MURASE, Tokyo (JP); Hiroaki KIKUSHIMA, Tokyo (JP)

(73) Assignee: NIPPON TELEGRAPH AND TELEPHONE CORPORATION, Tokyo (JP)

(21) Appl. No.: 18/709,822

(22) PCT Filed: Nov. 24, 2021
(86) PCT No.: PCT/JP2021/043008

§ 371 Date: May 14, 2024

(51) Int. Cl. G06V 20/40; G06T 7/00; G06T 7/62; G06T 7/70

(52) U.S. Cl. CPC G06V 20/44; G06T 7/0002; G06T 7/62; G06T 7/70; G06T 2207/30168; G06V 2201/07

(57) ABSTRACT

A video processing device according to an embodiment includes: a detection unit that detects at least one type of event that is likely to affect a quality of experience of a user for a video displayed by an application program; and a determination unit that determines a degree of influence of the event on the quality of experience for the video on the basis of a result of the detection by the detection unit.

### TECHNICAL FIELD

An embodiment of the present invention relates to a video processing device, a method, and a program.

### BACKGROUND ART

In recent years, in order to improve the level of user's satisfaction with a video (moving image) and improve the efficiency of resources, a method of controlling communication resources and the like on the basis of an intent has been studied and implemented.

Specifically, a quality of experience (QoE) requirement of a user for a video is regarded as the intent of the user, and a network (NW) resource, a server resource, and the like are appropriately allocated in order to satisfy this requirement. It is therefore necessary to accurately grasp the quality of experience of the user for the video and extract the intent from the situation of change in QoE.

Technologies for quantifying the quality of experience for a video distribution system are classified into subjective quality evaluation and objective quality evaluation.

In the subjective evaluation method, users who use an application program (hereinafter, sometimes referred to as an application or an app) are asked to score the quality, or asked to complete a questionnaire, and thus the users evaluate the quality of experience (see, for example, Non Patent Literature 1).

Furthermore, in the objective evaluation method, the quality of experience of a user is generally estimated on the basis of parameters (e.g., packet loss and jitter) regarding a communication environment and a situation (see, for example, Non Patent Literatures 2 to 4).

### CITATION LIST

### Non Patent Literature

Non Patent Literature 1: T. Hoßfeld, R. Schatz, M. Seufert, M. Hirth, T. Zinner, & P. Tran-Gia, (2011) “Quantification of YouTube (registered trademark) QoE via Crowdsourcing,” in IEEE International Workshop on Multimedia Quality of Experience—Modeling, Evaluation, and Directions (MQoE), Dana Point, CA, USA
Non Patent Literature 2: M. H. Pinson, & S. Wolf, (2004) “A New Standardized Method for Objectively Measuring Video Quality”, IEEE Transactions on Broadcasting, Vol. 50, pp. 312-322.
Non Patent Literature 3: F. Agboma & A. Liotta, (2008) “QoE-aware QOS management,” in Proceedings of the 6th International Conference on Advances in Mobile Computing and Multimedia, pp. 111-116
Non Patent Literature 4: V. A. Machado et al., “A new proposal to provide estimation of QOS and QoE over WiMAX networks: An approach based on computational intelligence and discrete-event simulation,” 2011 IEEE Third Latin-American Conference on Communications, 2011, pp. 1-6

### SUMMARY OF INVENTION

### Technical Problem

However, in the above subjective evaluation method, for an application program of a different type, it is necessary, for example, to ask the users to score the quality again in order to evaluate QoE, and there is a concern that this may require an enormous cost. In the above objective evaluation method, the method is based on the parameters acquired from the communication environment and the like, and it is therefore necessary to review the parameters for a different application program or a different communication method.

That is, in the existing technologies, a technical solution to evaluate QoE for an application in a versatile manner and extract the intent of a user has not been found.

The present invention has been made in view of the above circumstances, and an object thereof is to provide a video processing device, a method, and a program that allow for appropriate evaluation of quality of experience for a video.

### Solution to Problem

One aspect of the present invention provides a video processing device including: a detection unit that detects at least one type of event that is likely to affect a quality of experience of a user for a video displayed by an application program; and a determination unit that determines a degree of influence of the event on the quality of experience for the video on the basis of a result of the detection by the detection unit.

One aspect of the present invention provides a video processing method performed by a video processing device, the method including: detecting at least one type of event that is likely to affect a quality of experience of a user for a video displayed by an application program; and determining a degree of influence of the event on the quality of experience for the video on the basis of a result of the detection.

### Advantageous Effects of Invention

According to the present invention, it is possible to appropriately evaluate the quality of experience for a video.

### BRIEF DESCRIPTION OF DRAWINGS

FIG. 1 is a diagram illustrating an application example of a video processing device according to an embodiment of the present invention.

FIG. 2 is a diagram illustrating an example of a subject detected by a subject detection unit.

FIG. 3 is a diagram illustrating an example of a processing procedure by a stop determination unit.

FIG. 4 is a diagram illustrating an example of stop time calculation for one subject.

FIG. 5 is a diagram illustrating an example of update of the position of a subject and the size of the subject in a past time period.

FIG. 6 is a diagram illustrating an example of a processing procedure by a wait determination unit.

FIG. 7 is a diagram illustrating an example of wait duration calculation for a wait display.

FIG. 8 is a diagram illustrating an example of update of the position of the wait display and the size of the wait display in a past time period.

FIG. 9 is a diagram illustrating an example of a processing procedure by a pixelation determination unit.

FIG. 10 is a diagram illustrating an example of pixelation duration calculation for pixelation.

FIG. 11 is a diagram illustrating an example of update of the position of pixelation and the size of the pixelation in a past time period.

FIG. 12 is a diagram illustrating an example of a processing procedure by a QoE computation unit and an intent derivation unit.

FIG. 13 is a diagram illustrating an example of a subject, pixelation, and wait display detected from a screen of a web conference application.

FIG. 14 is a diagram illustrating a first example of a subject, pixelation, wait display, and score calculation detected at each time from a screen of a video distribution application.

FIG. 15 is a diagram illustrating a second example of a subject, pixelation, wait display, and score calculation detected at each time from a screen of a video distribution application.

FIG. 16 is a diagram illustrating a third example of a subject, pixelation, wait display, and score calculation detected at each time from a screen of a video distribution application.

FIG. 17 is a diagram illustrating a fourth example of a subject, pixelation, wait display, and score calculation detected at each time from a screen of a video distribution application.

FIG. 18 is a block diagram illustrating an example of a hardware configuration of the video processing device according to the embodiment of the present invention.

### DESCRIPTION OF EMBODIMENTS

Hereinafter, an embodiment according to the present invention will be described with reference to the drawings.

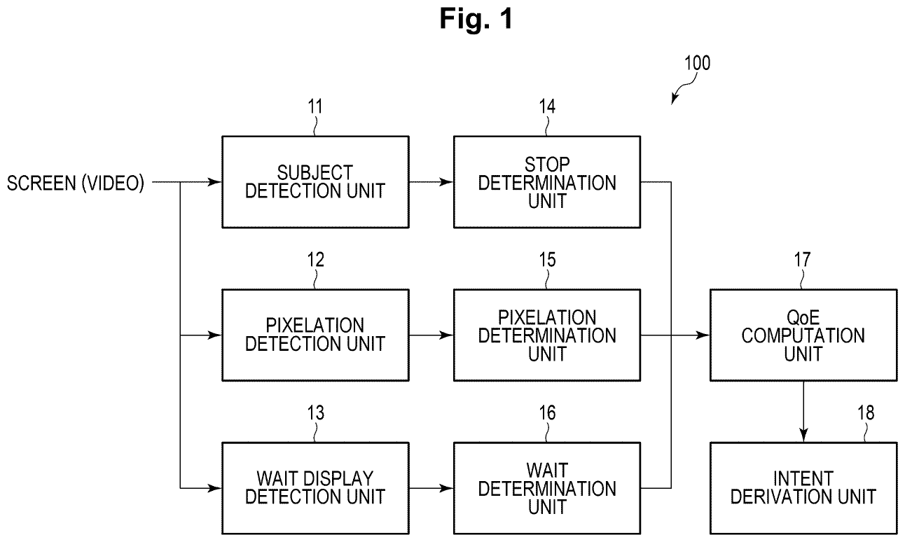

FIG. 1 is a diagram illustrating an application example of a video processing device according to the embodiment of the present invention.

As illustrated in FIG. 1, a video processing device 100 according to the embodiment of the present invention includes a subject detection unit 11, a pixelation detection unit 12, a wait display detection unit 13, a stop determination unit 14, a pixelation determination unit 15, a wait determination unit 16, a QoE computation unit 17, and an intent derivation unit 18.

The subject detection unit 11 captures a screen of an application as pieces of video (moving image) at a plurality of timings from the current time to a predetermined time in the past, detects the position and size of a subject, which is an object of interest to a user, that appears in the video at a target timing the subject appears in the video and a timing in the past that is consecutive to the target timing in time series, and outputs results of the detection to the stop determination unit 14 together with information regarding the target timing.

The pixelation detection unit 12 captures the screen of the application as pieces of video at a plurality of timings, detects the position and size of pixelation that appears in the video at a target timing the pixelation appears in the video, and outputs results of the detection to the pixelation determination unit 15 together with information regarding the target timing.

The wait display detection unit 13 captures the screen of the application as pieces of video at a plurality of timings, detects the position and size of a wait display that appears in the video at a target timing the wait display appears in the video, and outputs results of the detection to the wait determination unit 16 together with information regarding the target timing.

The subject detection unit 11, the pixelation detection unit 12, and the wait display detection unit 13 detect an event that may affect the quality of experience of a user for a video displayed by an application program.

Operations of the stop determination unit 14, the pixelation determination unit 15, the wait determination unit 16, the QoE computation unit 17, and the intent derivation unit 18 will be sequentially described below.

The subject detection unit 11, the pixelation detection unit 12, and the wait display detection unit 13 can be implemented by utilizing or retraining a commercial object detection library (e. g., yolo).

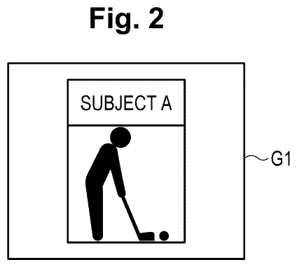

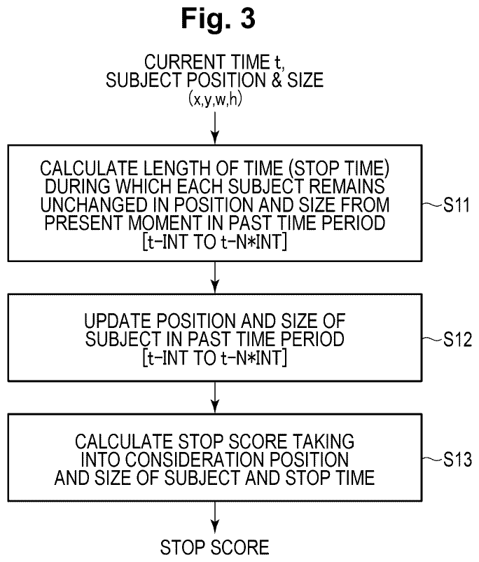

Next, processing by the stop determination unit 14 will be described. FIG. 2 is a diagram illustrating an example of a subject detected by the subject detection unit. FIG. 3 is a diagram illustrating an example of a processing procedure by the stop determination unit.

First, the stop determination unit 14 receives, from the subject detection unit 11, a current time (present moment) t, information regarding the position of a subject, and information regarding the size of the subject.

The position of the subject is constituted by a horizontal coordinate x of an upper left vertex of the subject to be detected, for example, a “subject A” illustrated in FIG. 2, and a vertical coordinate y of the upper left vertex of the subject.

The size of the subject is constituted by a width w of the subject and a height h of the subject. It is assumed that x, y, w, and h have all been normalized.

Next, when the subject is detected by the subject detection unit 11 in a video at the current time t, the stop determination unit 14 calculates a time, during which the subject remains unchanged in position and size, from a target timing between a past time period [t−INT to t−N*INT] and the current time t to a timing earlier than the target timing, that is, a length of a stop time, which is a time during which behavior of the subject is continuously stopped (S11).

Here, when a subject that is the same in position and size is detected at a target timing and a timing in the past that is consecutive to the target timing in time series, it is determined that the behavior of the subject is stopped during the time corresponding to these timings, and this time corresponds to the stop time of the subject at the target timing.

INT is a time interval between detections of a subject, pixelation, or wait display, and can be set by a system administrator of the video processing device 100.

t to N*INT is an interval between the current time (t) and N*INT, for example, a time range of detection of a subject, pixelation, or wait display on the screen, and can be set by the system administrator.

For example, in a case where the detection time interval INT is 5 [ms] and N is 100, the stop time, pixelation duration, wait duration, or the like described later is calculated on the basis of the subject, pixelation, or wait display during up to 500 [ms] (5 [ms]×100 times) from the present moment.

The stop determination unit 14 updates the position and size in the past time period [t−INT to t−N*INT] (S12).

The stop determination unit 14 calculates a stop score indicating the degree of influence of the subject whose behavior has stopped on the quality of experience of a user for the video, taking into consideration the position where the subject has stopped, the size of the stopped subject, and the length of the stop time calculated in S11, and then outputs the stop score (S13).

The stop score may be calculated for each of timings, among timings from the current time t to a past time “t−INT*N”, at which the subject is detected by the subject detection unit 11 and the behavior of the subject is determined to be stopped.

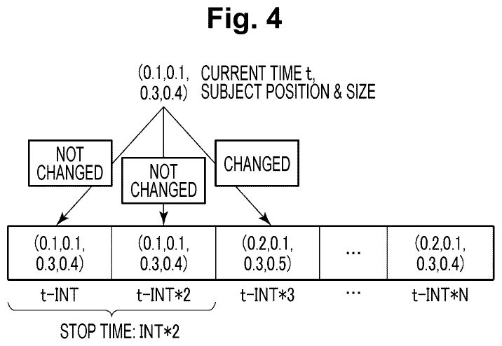

FIG. 4 is a diagram illustrating an example of stop time calculation for one subject.

The example illustrated in FIG. 4 shows that, at the current time t and from a time “t−INT” to a time “t−INT*2”, the parameters (x, y, w, h), which are the horizontal coordinate of the subject position, the vertical coordinate of the subject position, the width of the subject, and the height of the subject, are the same (0.1, 0.1, 0.3, 0.4), and at a time “t−INT*3” that is a time interval “INT” earlier than the time “t−INT*2”, the parameters change to (0.2, 0.1, 0.3, 0.5) as viewed from the time “t−INT*2”. In S11, the stop determination unit 14 calculates, as the stop time of the behavior of the subject at the current time t, a time “INT*2” during which the parameters remain unchanged as viewed from the current time t.

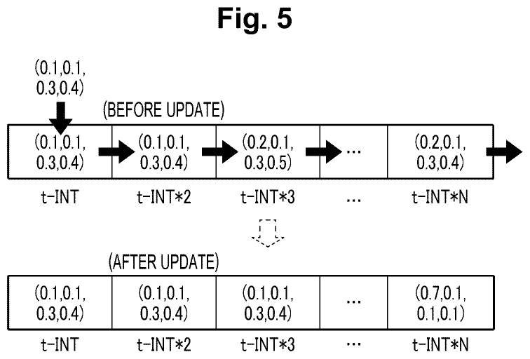

FIG. 5 is a diagram illustrating an example of update of the position of a subject and the size of the subject in a past time period.

The example illustrated in FIG. 5 shows that, in accordance with the new parameters (x, y, w, h) being (0.1, 0.1, 0.3, 0.4) at the current time t illustrated in FIG. 4, the stop determination unit 14 updates the parameters at the time “t−INT” illustrated in FIG. 4 with the parameters at the current time t in S12.

With this update, the parameters at the time “t−INT*2” illustrated in FIG. 4 are updated with the parameters at a time “t−INT*1” that is the time interval “INT” later than the time “t−INT*2” before the update, and the parameters at each of the other times are updated with the parameters at the time “t−INT*1” that is the time interval “INT” later than that time.

After the above update, in S13, the stop determination unit 14 calculates a stop score by using the following Formula (1), taking into consideration the position of the subject, the size of the subject, and the calculated length of the stop time.

$$Stop score = \sum ( area of subject * distance from center of subject to center of screen * stop time * weight ) \qquad Formula ( 1 )$$

Using this Formula (1), the stop score is calculated as follows, for example.

The coordinates of the center of the subject can be calculated from (x, y, w, h). The horizontal coordinate of the center of the subject and the vertical coordinate of the center of the subject are calculated by the following Formulas (2) and (3), respectively.

$$Horizontal coordinate of center of subject = x + w / 2 \qquad Formula ( 2 )$$

$$Vertical coordinate of center of subject = y - h / 2 \qquad Formula ( 3 )$$

When the maximum values of the horizontal coordinate and the vertical coordinate of the screen are 1, the coordinates of the center of the screen are (0.5, 0.5).

Then, a distance dis from the center of the subject to the center of the screen is calculated by the following Formula (4).

$$\begin{matrix}[ Math . 1 ] & \\ dis = \sqrt{{( x + \frac{w}{2} - 0.5 )}^{2} + {x ( y - \frac{h}{2} - 0.5 )}^{2}} & Formula ( 4 )\end{matrix}$$

That is, the stop score can be calculated by the following Formula (5).

$$Stop score = w ⋆ h ⋆ dis * stop time * weight \qquad Formula ( 5 )$$

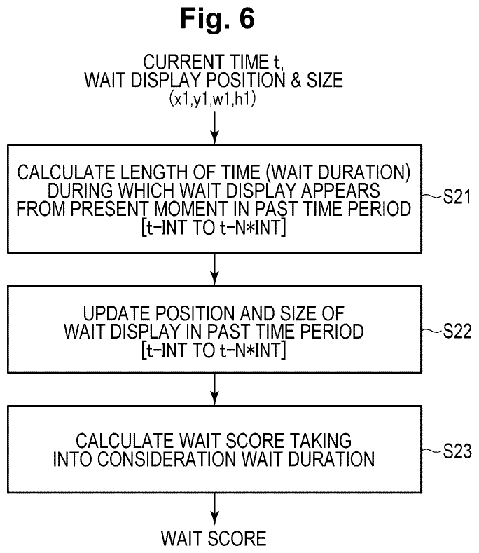

Next, processing by the wait determination unit 16 will be described. FIG. 6 is a diagram illustrating an example of a processing procedure by the wait determination unit.

First, the wait determination unit 16 receives, from the wait display detection unit 13, the current time t and parameters (x1, y1, w1, h1), which are information regarding the position of a wait display and information regarding the size of the wait display.

The position of a wait display is constituted by a horizontal coordinate x1 of an upper left vertex of a detection target and a vertical coordinate y1 of the upper left vertex of the detection target. The size of a wait display is constituted by a width w1 of a detection target and a height h1 of the detection target. It is assumed that x1, y1, w1, and h1 have all been normalized.

Next, the wait determination unit 16 calculates the length of a wait duration, which is the time during which a wait display continuously appears in the video, from a target timing between the past time period [t−INT to t−N*INT] and the current time t to a timing earlier than the target timing (S21).

The wait determination unit 16 updates the position and size of the wait display in the past time period [t−INT to t−N*INT] (S22).

The wait determination unit 16 calculates a wait score indicating the degree of influence of the wait display on the quality of experience of a user for the video, taking into consideration the wait duration calculated in S21, and outputs the wait score (S23).

The wait score may be calculated for each of timings, among timings from the current time t to the past time “t−INT*N”, at which the wait display is detected by the wait display detection unit 13.

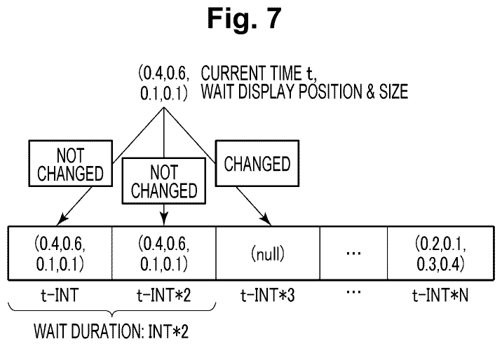

FIG. 7 is a diagram illustrating an example of wait duration calculation for a wait display.

The example illustrated in FIG. 7 shows that, at the current time t, the time “t−INT”, and the time “t−INT*2”, the parameters (x1, y1, w1, h1), which are the horizontal coordinate of the wait display, the vertical coordinate of the wait display, the width of the wait display, and the height of the wait display, are the same (0.4, 0.6, 0.1, 0.1), and at the time “t−INT*3” that is the time interval “INT” earlier than the time “t−INT*2”, the parameters change to (null) as viewed from the time “t−INT*2”. In S21, the wait determination unit 16 calculates, as the wait duration at the current time t, the time “INT*2” during which the parameters remain unchanged as viewed from the current time t.

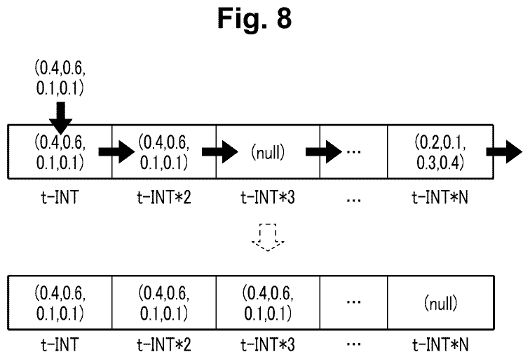

FIG. 8 is a diagram illustrating an example of update of the position of the wait display and the size of the wait display in a past time period.

The example illustrated in FIG. 8 shows that, in accordance with the parameters (x1, y1, w1, h1) being (0.4, 0.6, 0.1, 0.1) at the current time t illustrated in FIG. 7, the wait determination unit 16 updates the parameters at the time “t−INT” illustrated in FIG. 7 with the parameters at the current time t in S22.

With this update, the parameters at the time “t−INT*2” illustrated in FIG. 7 are updated with the parameters at the time “t−INT*1” that is the time interval “INT” later than the time “t−INT*2” before the update, and the parameters at each of the other times are updated with the parameters at the time “t−INT*1” that is the time interval “INT” later than that time.

After the above update, in S23, the wait determination unit 16 calculates a wait score by using the following Formula (6) taking into consideration the wait duration.

$$Wait score = presence cr absence of wait display + wait duration * weight \qquad Formula ( 6 )$$

When the wait display appears on the screen, the presence or absence of wait display is “1”, and when the wait display does not appear on the screen, the presence or absence of wait display is “0”.

Using the above Formula (6), the wait score is calculated as follows, for example.

$$Wait score = 1 + ( INT * 2 ) * weight$$

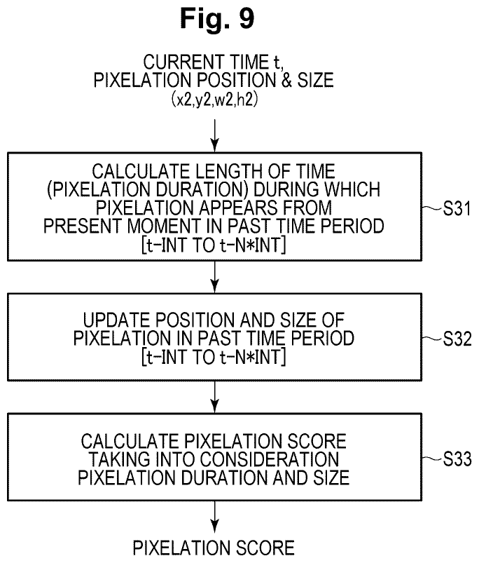

Next, processing by the pixelation determination unit 15 will be described. FIG. 9 is a diagram illustrating an example of a processing procedure by the pixelation determination unit.

First, the pixelation determination unit 15 receives, from the pixelation detection unit 12, the current time t and parameters (x2, y2, w2, h2), which are information regarding the position of pixelation and information regarding the size of the pixelation.

The position of pixelation is constituted by a horizontal coordinate x2 of an upper left vertex of a detection target and a vertical coordinate y2 of the upper left vertex of the detection target. The size of pixelation is constituted by a width w2 of a detection target and a height h2 of the detection target. It is assumed that x2, y2, w2, and h2 have all been normalized.

Next, the pixelation determination unit 15 calculates the length of a pixelation duration, which is the time during which pixelation continuously appears in the video, from a target timing between the past time period [t−INT to t−N*INT] and the current time t to a timing earlier than the target timing (S31). The pixelation determination unit 15 updates the position and size of the pixelation in the past time period [t−INT to t−N*INT] (S32).

The pixelation determination unit 15 calculates a pixelation score indicating the degree of influence of the pixelation on the quality of experience of a user for the video, taking into consideration the pixelation size and the pixelation duration calculated in S31, and outputs the pixelation score (S33).

The pixelation score may be calculated for each of timings, among timings from the current time t to the past time “t−INT*N”, at which the pixelation is detected by the pixelation detection unit 12.

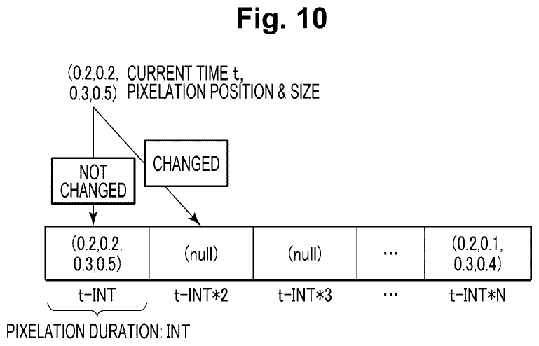

FIG. 10 is a diagram illustrating an example of pixelation duration calculation for pixelation.

The example illustrated in FIG. 10 shows that, at the current time t and the time “t−INT”, the parameters (x2, y2, w2, h2), which are the horizontal coordinate of the pixelation, the vertical coordinate of the pixelation, the width of the pixelation, and the height of the pixelation, are the same (0.2, 0.2, 0.3, 0.5), and at the time “t−INT*2” that is the time interval “INT” earlier than the time “t−INT*1”, the parameters change to (null) as viewed from the time “t−INT*1”.

In S31, the pixelation determination unit 15 calculates, as the pixelation duration at the current time t, the time “INT” during which the parameters remain unchanged as viewed from the current time t.

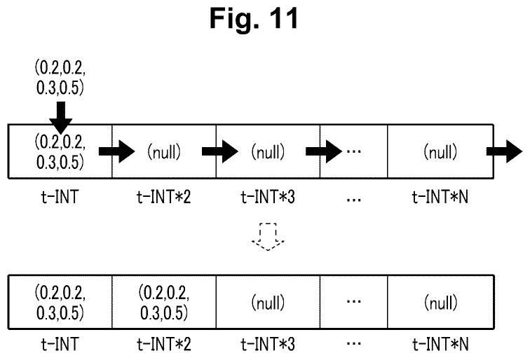

FIG. 11 is a diagram illustrating an example of update of the position of pixelation and the size of the pixelation in a past time period.

The example illustrated in FIG. 11 shows that, in accordance with the new parameters (x2, y2, w2, h2) being (0.2, 0.2, 0.3, 0.5) at the current time t illustrated in FIG. 10, the pixelation determination unit 15 updates the parameters at the time “t−INT” illustrated in FIG. 10 with the parameters at the current time t in S32.

With this update, the parameters at the time “t−INT*2” illustrated in FIG. 10 are updated with the parameters at the time “t−INT*1” that is the time interval “INT” later than the time “t−INT*2” before the update, and the parameters at each of the other times are updated with the parameters at the time “t−INT*1” that is the time interval “INT” later than that time.

After the above update, in S33, the pixelation determination unit 15 calculates a pixelation score by using the following Formula (7) taking into consideration the pixelation duration.

$$Pixelation score = presence or absence of pixelation + pixelation duration * pixelation size * weight \qquad Formula ( 7 )$$

When the pixelation appears on the screen, the presence or absence of pixelation is “1”, and when the pixelation does not appear on the screen, the presence or absence of the pixelation is “0”.

Using Formula (7), the pixelation score is calculated as follows, for example.

$$Pixelation score = 1 + INT ⋆ ( 0.3 ⋆ 0.5 ) ⋆ Weight$$

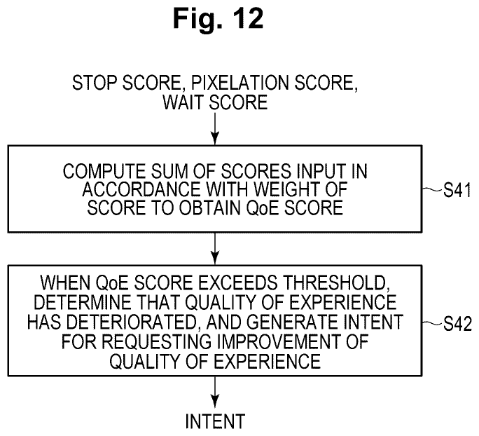

Next, processing by the QoE computation unit 17 and the intent derivation unit 18 will be described. FIG. 12 is a diagram illustrating an example of a processing procedure by the QoE computation unit and the intent derivation unit.

First, the QoE computation unit 17 receives a stop score output from the stop determination unit 14, a pixelation score output from the pixelation determination unit 15, and a wait score output from the wait determination unit 16.

The QoE computation unit 17 multiplies each of the received stop score, pixelation score, and wait score by a predetermined weight corresponding to the score type and then computes the sum of the scores, thereby computing a QoE score indicating the degree of influence of stopping of the behavior of the subject, the pixelation, and the wait display on the quality of experience of a user (S41).

The QoE score may be calculated for each of the timing at which the stop score is calculated, the timing at which the wait score is calculated, and the timing at which the pixelation score is calculated, among timings from the current time t to the past time “t−INT*N”.

When the computed QoE score exceeds a threshold, the intent derivation unit 18 determines that the quality of experience of the user for the video has deteriorated, generates an intent for requesting improvement of the quality of experience of the user, and outputs the intent (S42). The intent may be generated for each timing at which the QoE score is calculated, among timings from the current time t to the past time “t−INT*N”.

Next, an example in which the video processing device 100 according to the present embodiment is applied to a web conference application will be described.

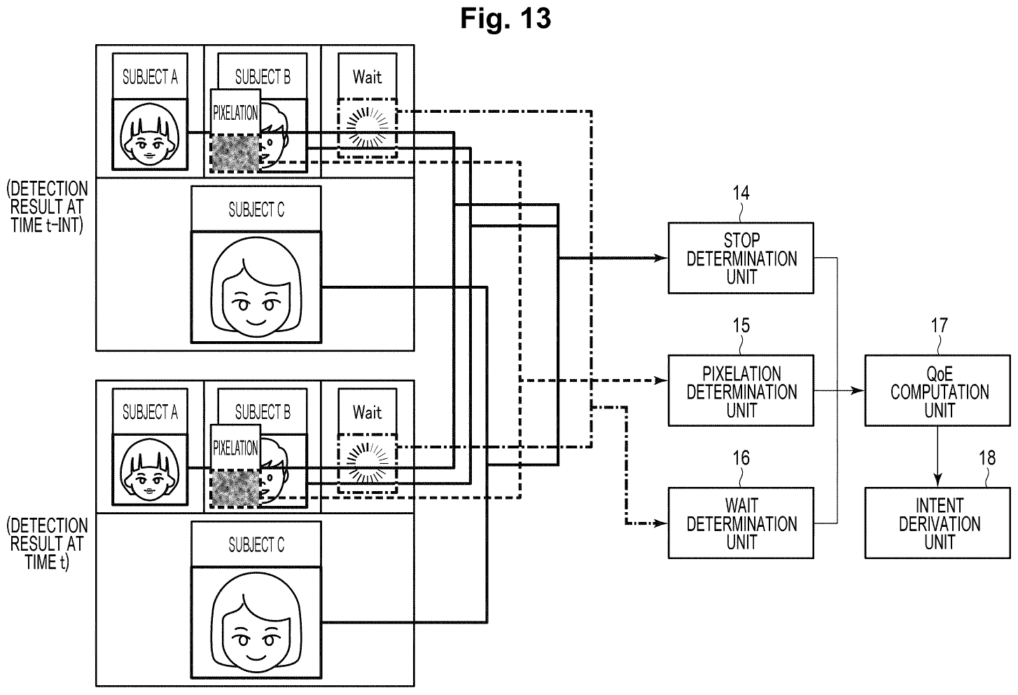

FIG. 13 is a diagram illustrating an example of a subject, pixelation, and wait display detected from the screen of the web conference application.

The example illustrated in FIG. 13 shows that subjects (subject A, subject B, and subject C), pixelation, and wait display (Wait) have been detected at each of the time “t−INT” and the current time t. Here, in order to simplify the description, it is assumed that “N” in “N*INT” described above is 1.

In the example illustrated in FIG. 13, since the subjects B and C remain unchanged in position and size during the time from the time “t−INT” to the current time t, the stop determination unit 14 calculates the time from the time “t−INT” to the current time t as a stop time of the behavior of the subject at the current time t, and then calculates a stop score at the current time t taking into consideration the stop time. In this example, the subject B, which is relatively large in size and is close to the center of the screen, has a relatively large influence on the stop score.

In the example illustrated in FIG. 13, the pixelation is continuously detected between the current time t and the time “t−INT”, and thus, the pixelation determination unit 15 calculates this time as the pixelation duration at the current time t, and calculates a pixelation score at the current time t taking into consideration this time and the size of the pixelation.

In the example illustrated in FIG. 13, the wait display is continuously detected between the current time t and the time “t−INT”, and thus, the wait determination unit 16 calculates this time as the wait duration at the current time t, and then calculates a wait score at the current time t taking into consideration this time.

On the basis of the calculated stop score, pixelation score, and wait score for the same timing, the QoE computation unit 17 calculates a QoE score for this timing.

In addition, the intent derivation unit 18 compares the calculated QoE score with a set threshold, and issues an intent for requesting improvement of the quality of experience of the user in a case where it is determined that the quality of experience of the user has deteriorated.

Next, examples of a case where the video processing device 100 according to the present embodiment is applied to a video distribution application will be described.

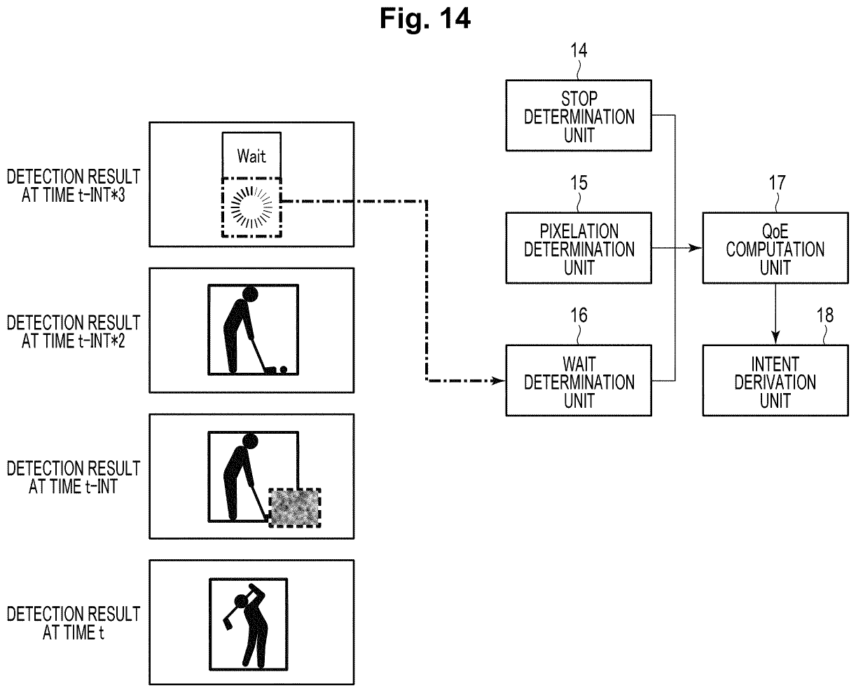

FIG. 14 is a diagram illustrating a first example of a subject, pixelation, wait display, and score calculation detected at each time from a screen of a video distribution application.

In the example illustrated in FIG. 14, the wait display (Wait) is detected at the time “t−INT*3”, and the wait determination unit 16 calculates a wait score at this time “t−INT*3”.

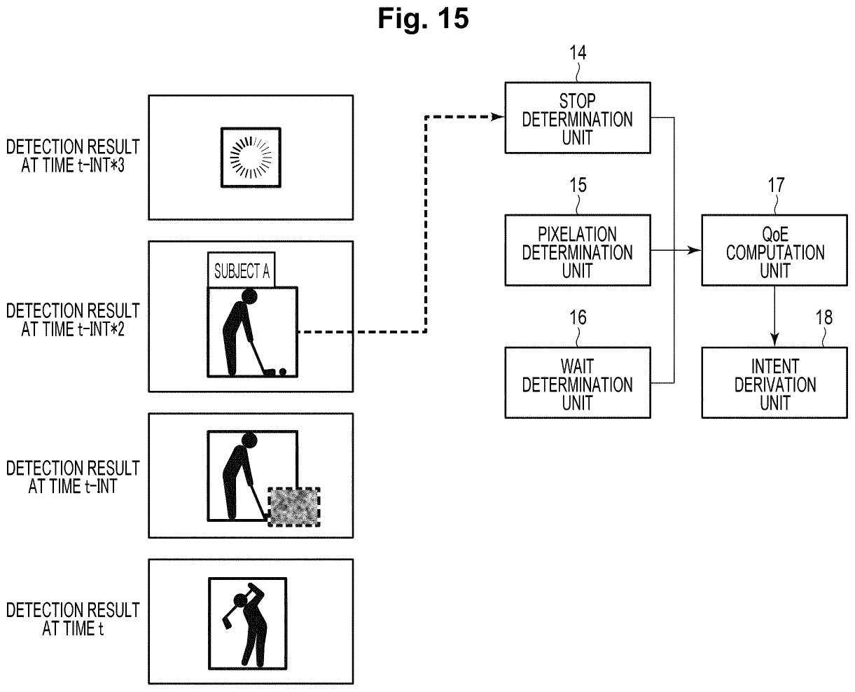

FIG. 15 is a diagram illustrating a second example of a subject, pixelation, wait display, and score calculation detected at each time from a screen of a video distribution application.

The example illustrated in FIG. 15 shows that the subject and pixelation are detected at the time “t−INT*1”, and the subject is detected at the current time t.

In the example illustrated in FIG. 15, the “subject A” is detected at the time “t−INT*2”, but the subject is not detected at the time “t−INT*3” that is one interval earlier than that time, and thus, the stop determination unit 14 determines that the behavior of the subject has not been stopped at the time “t−INT*2”.

Therefore, a user QoE score at the time “t−INT*2” is not calculated, and no intent is output.

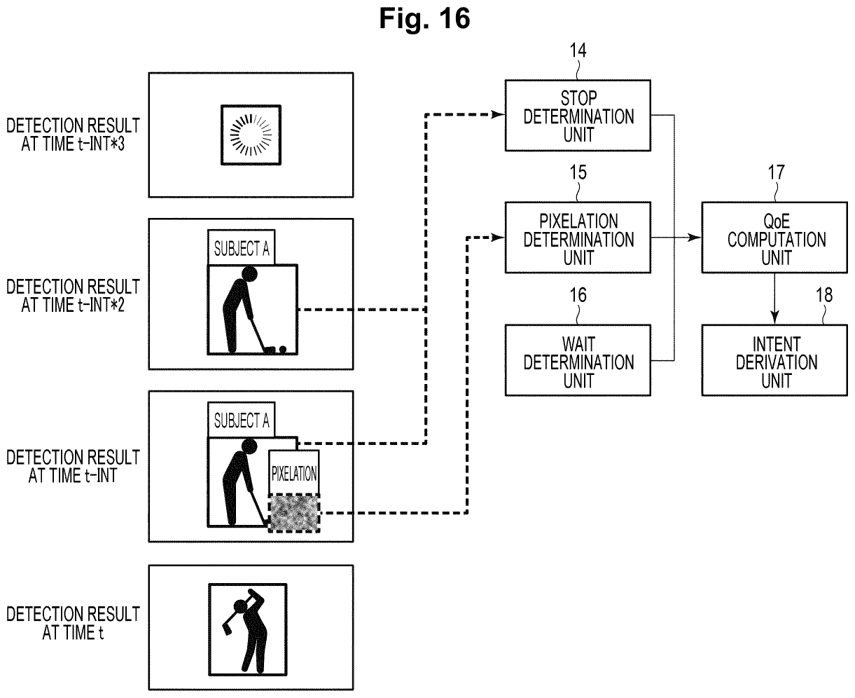

FIG. 16 is a diagram illustrating a third example of a subject, pixelation, wait display, and score calculation detected at each time from a screen of a video distribution application.

In the example illustrated in FIG. 16, the “subject A” is detected at the time “t−INT”, the “subject A” is also detected at the previous time “t−INT*2” that is consecutive to the time “t−INT” in time series, and the position and size of the “subject A” remain unchanged between these times. Thus, the stop determination unit 14 determines that the behavior of the subject has been stopped at the time “t−INT”, and calculates a stop score at this time “t−INT”.

In the example illustrated in FIG. 16, pixelation is detected at the time “t−INT”, and the pixelation determination unit 15 calculates a pixelation score at the time “t−INT”.

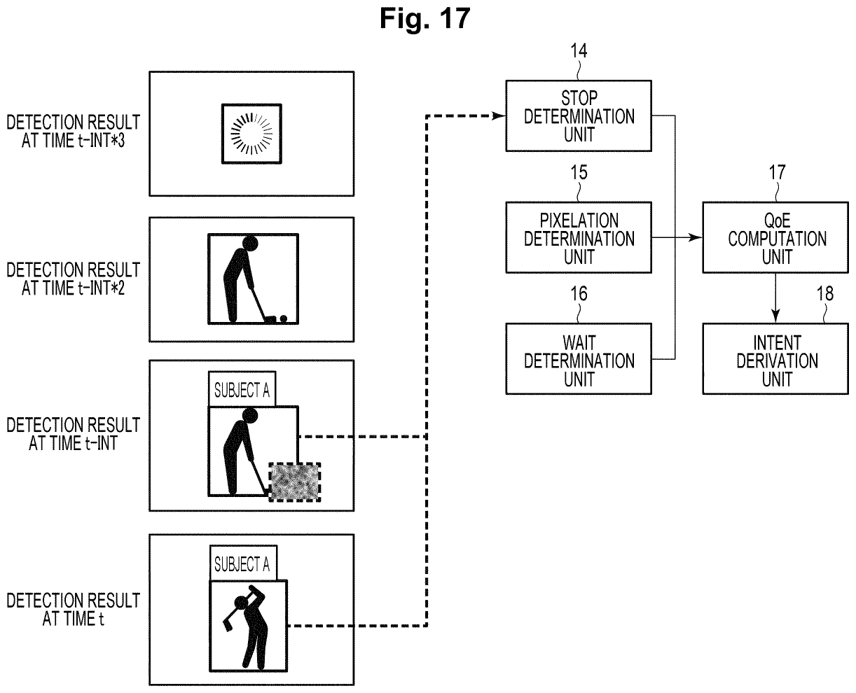

FIG. 17 is a diagram illustrating a fourth example of a subject, pixelation, wait display, and score calculation detected at each time from a screen of a video distribution application.

In the example illustrated in FIG. 17, the “subject A” is detected at the current time t, the “subject A” is also detected at the previous time “t−INT” that is consecutive to the time t in time series, and the position and size of the “subject A” change between the current time t and the time “t−INT”. Thus, the stop determination unit 14 determines that the behavior of the subject has not been stopped at the time “t−INT”. Therefore, a user QoE score at the current time t is not calculated.

On the basis of the calculated stop score, pixelation score, and wait score for the same timing, the QoE computation unit 17 calculates a QoE score for this timing.

In addition, the intent derivation unit 18 compares the calculated QoE score with a set threshold, and issues an intent for requesting improvement of the quality of experience of the user in a case where it is determined that the quality of experience of the user has deteriorated.

In the embodiment of the present invention described above, an index that affects the quality of experience of a user is determined from a video displayed on a screen by an application program for video, and the quality of experience of the user for the video can be evaluated in a versatile manner for various types of application programs.

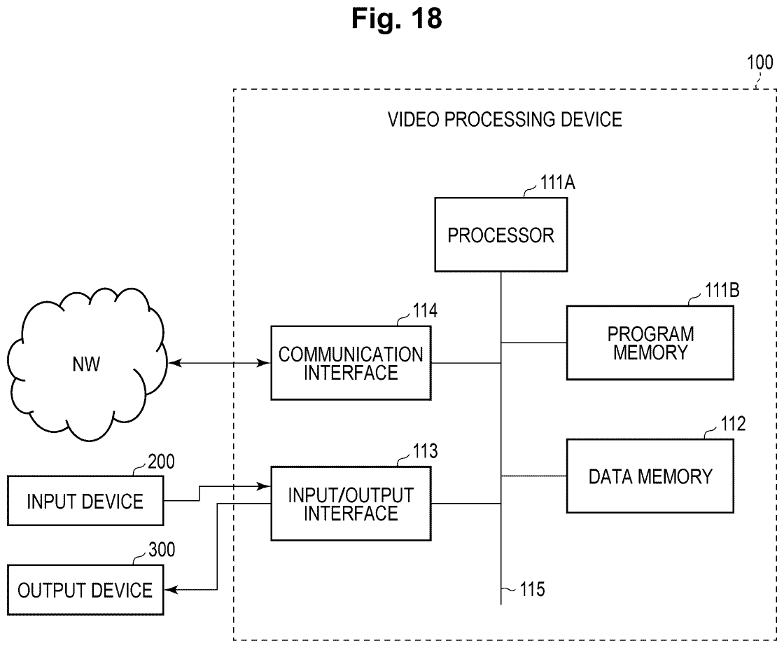

FIG. 18 is a block diagram illustrating an example of a hardware configuration of the video processing device according to the embodiment of the present invention.

In the example illustrated in FIG. 18, the video processing device 100 according to the embodiment is constituted by, for example, a server computer or a personal computer, and includes a hardware processor 111A such as a central processing unit (CPU). In addition, a program memory 111B, a data memory 112, an input/output interface 113, and a communication interface 114 are connected to the hardware processor 111A via a bus 115.

The communication interface 114 includes, for example, one or more wireless communication interface units and enables transmission/reception of information to/from a communication network NW. The wireless interface can be, for example, an interface in which a low-power wireless data communication standard such as a wireless local area network (LAN) is adopted.

The input/output interface 113 is connected to an input device 200 and an output device 300 that are attached to the video processing device 100 and are used by a user or the like.

The input/output interface 113 performs processing of retrieving operation data input by a user or the like via the input device 200 such as a keyboard, a touch panel, a touchpad, or a mouse, and outputting output data to the output device 300 including a display device using liquid crystal, organic electro luminescence (EL), or the like to display the output data. The input device 200 and the output device 300 may be devices included in the video processing device 100 or may be an input device and an output device of another information terminal that can communicate with the video processing device 100 via the network NW.

The program memory 111B is used as a non-transitory tangible storage medium, for example, as a combination of a non-volatile memory that enables writing and reading as necessary, such as a hard disk drive (HDD) or a solid state drive (SSD), and a non-volatile memory such as a read only memory (ROM), and stores programs necessary for executing various kinds of control processing according to the embodiment and the like.

The data memory 112 is used as a tangible storage medium, for example, as a combination of the above-described non-volatile memory and a volatile memory such as a random access memory (RAM), and is used to store various kinds of data acquired and created during various kinds of processing.

The video processing device 100 according to the embodiment of the present invention can be configured as a data processing device including, as processing function units by software, the subject detection unit 11, the pixelation detection unit 12, the wait display detection unit 13, the stop determination unit 14, the pixelation determination unit 15, the wait determination unit 16, the QoE computation unit 17, and the intent derivation unit 18 illustrated in FIG. 1.

Each information storage unit used as a working memory or the like by each unit of the video processing device 100 can be configured by using the data memory 112 illustrated in FIG. 18. However, those configured storage areas are not essential configurations in the data analysis device 1 and may be areas provided in, for example, an external storage medium such as a universal serial bus (USB) memory or a storage device such as a database server arranged in a cloud.

All the processing function units in the subject detection unit 11, the pixelation detection unit 12, the wait display detection unit 13, the stop determination unit 14, the pixelation determination unit 15, the wait determination unit 16, the QoE computation unit 17, and the intent derivation unit 18 can be implemented by causing the hardware processor 111A to read and execute the programs stored in the program memory 111B. Note that some or all of these processing function units may be implemented in other various forms including an integrated circuit such as an application specific integrated circuit (ASIC) or a field-programmable gate array (FPGA).

The methods described in each embodiment can be stored in a recording medium such as a magnetic disk (e.g., floppy (registered trademark) disk or hard disk), an optical disc (e.g., CD-ROM, DVD, or MO), or a semiconductor memory (e.g., ROM, RAM, or flash memory) as a program (software means) that can be executed by a computer, and can be distributed by being transmitted through a communication medium. The programs stored in the medium also include a setting program for configuring, in the computer, software means (including not only an execution program but also a table and a data structure) to be executed by the computer. The computer that implements the present device executes the above processing by reading the programs recorded in the recording medium, constructing the software means by the setting program as needed, and controlling operation by the software means. Note that the recording medium described in the present specification is not limited to a recording medium for distribution, but includes a storage medium such as a magnetic disk or a semiconductor memory provided in the computer or in a device connected via a network.

Note that the present invention is not limited to the above embodiment, and various modifications can be made in the implementation stage without departing from the gist of the invention. Also, embodiments may be implemented in an appropriate combination, and, in that case, effects as a result of the combination can be achieved. Furthermore, the above embodiment includes various inventions, and various inventions can be extracted by combinations selected from a plurality of disclosed components. For example, even if some components are deleted from all the components described in the embodiment, a configuration from which the components have been deleted can be extracted as an invention, as long as the problem can be solved and the effects can be achieved.

### REFERENCE SIGNS LIST

100 Video processing device
11 Subject detection unit
12 Pixelation detection unit
13 Wait display detection unit
14 Stop determination unit
15 Pixelation determination unit
16 Wait determination unit
17 QoE computation unit
18 Intent derivation unit

1. A video processing device comprising:
a detector that detects at least one type of event that is likely to affect a quality of experience of a user for a video displayed by an application program; and
determination circuitry that determines a degree of influence of the event on the quality of experience for the video on the basis of a result of the detection by the detector.

2. The video processing device according to claim 1, wherein:
the detector is configured to:
detect each of an object that appears in the video, pixelation that appears in the video, and a wait display that appears in the video, and
the determination circuitry is configured to:
compute a first score indicating a degree of influence of a stopped state on the quality of experience, the stopped state being a state in which behavior of the object detected by the detector remains stopped while time elapses, a second score indicating a degree of influence of the pixelation detected by the detector on the quality of experience, and a third score indicating a degree of influence of the wait display detected by the detector on the quality of experience; and
determine a degree of influence of the event on the quality of experience on the basis of the computed first, second, and third scores.

3. The video processing device according to claim 2, wherein the determination circuitry is configured to:
determine a duration of the state in which the behavior of the object remains stopped in a case where the object detected by the detector remains unchanged in position and size while time elapses; and
compute the first score on the basis of the position of the object, the size of the object, and the duration of the state in which the behavior of the object remains stopped.

4. The video processing device according to claim 2, wherein the determination is configured to:
determine a time during which the pixelation detected by the detector continuously appears in the video, and compute the second score on the basis of a size of the pixelation and the time during which the pixelation continuously appears in the video.

5. The video processing device according to claim 2, wherein the determination is configured to;
determine a time during which the wait display detected by the detector continuously appears in the video, and compute the third score on the basis of the time during which the wait display continuously appears in the video.

6. A video processing method, comprising:
detecting at least one type of event that is likely to affect a quality of experience of a user for a video displayed by an application program; and
determining a degree of influence of the event on the quality of experience for the video on the basis of a result of the detection.

7. The video processing method according to claim 6, wherein:
the detecting includes:
detecting each of an object that appears in the video, pixelation that appears in the video, and a wait display that appears in the video, and
the determining includes:
computing a first score indicating a degree of influence of a stopped state on the quality of experience, the stopped state being a state in which behavior of the detected object remains stopped while time elapses, a second score indicating a degree of influence of the detected pixelation on the quality of experience, and a third score indicating a degree of influence of the detected wait display on the quality of experience; and
determining a degree of influence of the event on the quality of experience on the basis of the computed first, second, and third scores.

8. A non-transitory computer readable medium storing a video processing program for causing a processor to perform the method of claim 6.
